(19) United States
(12) Patent Application Publication
(10) Pub. No.: US 2009/0183250 A1
(43) Pub. Date: Jul. 16, 2009

(54) APPARATUS, SYSTEM, AND METHOD FOR TRANSFERRING AUTHORITY

(76) Inventor: Noriaki Harada, Tokyo (JP)

Correspondence Address: NEC CORPORATION OF AMERICA, 6535 N. STATE HWY 161, IRVING, TX, 75039, US

(21) Appl. No.: 12/353,150

(22) Filed: Jan. 13, 2009

(30) Foreign Application Priority Data
Jan. 15, 2008 (JP) 5806/2008

(51) Int. Cl. H04L 9/32; G06F 21/00

(52) U.S. Cl. 726/9

(57) ABSTRACT

In a system for transferring authority, a transfer token providing unit provides a transfer token to transfer a token of a first user to a third party based on a request from a first terminal. A releasing unit releases the transfer token provided by the transfer token providing unit. A utilizing transfer token providing unit provides, when a request to obtain the transfer token released by the releasing unit is received from a second terminal, a utilizing transfer token to make the requested transfer token available to a second user, and provides the utilizing transfer token to the second user.

This application is based upon and claims the benefit of priority from Japanese Patent Application No. 2008-005806, filed on Jan. 15, 2008, the disclosure of which is incorporated herein in its entirety by reference.

### BACKGROUND OF THE INVENTION

1. Field of the Invention

The present invention relates to an apparatus, system, and method for transferring a token substantializing an authority of various services such as contents between users.

2. Description of the Related Art

Recently, more incidents of misrepresentation and impersonation have occurred in selling/buying contents, auctions, and the like on the Internet. For example, when a user utilizes a content, the user registers his/her privacy information (user attribute information such as name, address, and telephone number of the user) with a service provider providing the content. However, the service provider has no means to verify the credibility of the user attribute information registered by the user. Therefore, the service provider cannot confirm whether or not the user attribute information registered by the user is authorized user attribute information.

In addition, in an auction or the like, users release their user attribute information to each other after they made a deal to transfer a good or content. In this case, the users cannot verify the credibility of the user attribute information released between them. Therefore, the users cannot confirm whether or not the user attribute information released by the other party is authorized user attribute information. On the other hand, when a user releases his/her authorized user attribute information to the other party, a malicious third party may misuse the authorized user attribute information.

Under the above-mentioned circumstances, JP 2004-70591 A, filed prior to the present invention, objectifies authority to utilize a service as data and commercially distributes the data as a token. According to JP 2004-70591 A, in order to hand over an electronic ownership certificate (certificate of owner of merchandise) from a seller side to a buyer side in a selling/buying transaction, the escrow mediating business side server device discards the electronic ownership certificate on the seller side and provides the electronic ownership certificate to the buyer side. Further, in order to hand over an electronic claim certificate (certificate of owner of value paid for merchandise) from the buyer side to the seller side, the escrow mediating business side server device discards the electronic claim certificate on the buyer side and provides the electronic claim certificate to the seller side. As a result, the escrow mediating business side server device improves the convenience by simplifying the selling/buying transaction without damaging the reliability of the escrow.

According to JP 2004-70591 A, user A can transfer token A to user B, and user B can obtain token A of user A. However, there is a problem in that, when user B utilizes token A, user B cannot receive the same level of service as user A.

For example, as illustrated in FIG. 16, “user A” is registered with a content provider as a “premium member”. It is assumed that “user A” can utilize various services of “contents” as the “premium member”. On the other hand, as illustrated in FIG. 16, “user B” is registered with the content provider as a “basic member”. It is assumed that “user B” can utilize only specific services of the “contents” as the “basic member”. In this situation, as illustrated in FIG. 16, “user A” transfers to “user B” “token A” with which various services of “content A” are available. Then, “user B” tries to utilize the various services of “content A” with “token A”. However, “user B” cannot utilize the various services of “content A” to the same level as “user A” even with “token A” because “user B” is the “basic member”.

Consequently, a system is desired in which, when the class (premium member) of “user A” being a transfer source and the class (basic member) of “user B” being a transfer destination are different, “user B” can utilize “token A” in the class (premium member) of “user A”.

JP 2001-243311 A, filed prior to the present invention, discloses the system for smoothly supplying activity funds to an owner of a content. According to JP 2001-243311 A, the system securitizes the intellectual property of the content, provides the content securities to investors, and smoothly supplies the activity funds to the owner of the content.

JP 2003-345762 A discloses the system for preventing illegal contents from being downloaded without making processing procedures between providers complex. According to JP 2003-345762 A, a content delivery apparatus provides an access key (identifier for validating various requests from terminal) The access key is different from an access token (right to utilize content) provided by a content selling provider. Then, the content delivery apparatus internally utilizes the access key and manages access from the terminal independently of the content selling provider. In other words, by using both the access token and the access key, the system enhances the shielding property of the content delivery apparatus and can prevent the illegal contents from being downloaded without making the processing procedures between the providers complex.

JP 2004-30326 A discloses the system for giving a license to a user of a content to control utilization of the content and protect the content.

According to JP 2004-30326 A, the system uses data including a nonce generated by an authorized device utilizing the content and authentication information associated with a contents use permission authorizer, as a license token. Then, the authorized device utilizing the content permits the use of the corresponding content when the license token includes the nonce generated by the authorized device and the license token is valid in authenticating the authentication information. In this manner, the system controls the use of the content in order to protect the content.

JP 2004-164299 A discloses the system for enabling transfer of the right to directly utilize a content between terminals, and for automatically obtaining the approval of a copyright owner. According to JP 2004-164299 A, the system enables the transfer of a ticket indicating the right to utilize the content between the terminals. Also in the system, when the ticket is transferred between the terminals, a transfer monitoring server verifies whether or not the ticket transfer satisfies a content utilizing condition. In this manner, the user obtains the approval of the copyright owner of the content and transfers the ticket.

JP 2006-18692 A discloses the system for enabling transfer of an electronic right while maintaining the anonymity of a transfer source user and a transfer destination user. According to JP 2006-18692 A, right transfer processor 10, which is used by the transfer source user, creates right transfer information. Right transfer processor 10 generates a distributed information group in which the right transfer information is partially restorable from a combination of specified distributed information I and II. Right transfer processor 10 also generates a distributed information group in which the right transfer information is entirely restorable from a combination of all distributed information I, II, and III. Then, right transfer processor 10 transmits distributed information I and II to right receiver processor 20, which is used by the transfer destination user, and distributed information III to right transfer management device 30, which is used by a right manager. Right receiver processor 20 partially restores the right transfer information from distributed information I and II to confirm the content thereof, and then transmits distributed information I and II to right transfer management device 30. Right transfer management device 30 entirely restores the right transfer information from distributed information I, II, and III to verify the transfer of the electronic right, and executes the transfer processing of the electronic right. In this manner, the electronic right can be transferred while maintaining the anonymity of the transfer source user and the transfer destination user.

The above-mentioned patent documents disclose different security technologies in utilizing contents. However, the above-mentioned patent documents neither describe nor suggest, when a token obtained from a first user is utilized by a second user, the need for the second user to utilize the token in the class of the first user.

### SUMMARY OF THE INVENTION

An object of the present invention is to provide an apparatus, system, and method for transferring authority, in which, when a token obtained from a first user is utilized by a second user, the second user can utilize the token in a class of the first user.

According to one aspect of the present invention, an apparatus for transferring authority from a first user to a second user is provided, which includes: a transfer token providing unit for providing a transfer token to transfer a token from the first user to a third party; a releasing unit for releasing the transfer token; and a utilizing transfer token providing unit for providing a utilizing transfer token, the utilizing transfer token including a class of services for the first user.

Further, the utilizing transfer token providing unit receives a request to obtain the transfer token released by the releasing unit from the second user. The utilizing transfer token providing unit provides the utilizing transfer token, the utilizing transfer token making the transfer token available to the second user. The utilizing transfer token providing unit provides the utilizing transfer token to the second user.

According to another aspect of the present invention, a system for transferring authority from a first user to a second user is provided, which includes: an apparatus for transferring authority; a first terminal; and a second terminal, in which the apparatus includes a transfer token providing unit for providing a transfer token to transfer a token from the first user to a third party based on a request from the first terminal, a releasing unit for releasing the transfer token, and a utilizing transfer token providing unit for providing a utilizing transfer token, the utilizing transfer token including a class of services for the first user.

Further, the utilizing transfer token providing unit receives a request to obtain the transfer token released by the releasing unit from the second terminal. The utilizing transfer token providing unit provides the utilizing transfer token, the utilizing transfer token making the transfer token available to the second user. The utilizing transfer token providing unit provides the utilizing transfer token to the second user.

According to still another aspect of the present invention, a method for transferring authority from a first user to a second user is provided, which includes: (a) providing a transfer token to transfer a token from the first user to a third party; (b) releasing the transfer token; (c) providing a utilizing transfer token, the utilizing transfer token including a class of services for the first user; (d) receiving a request to obtain the transfer token released in step (b) from the second user; (e) providing the utilizing transfer token, the utilizing transfer token making the transfer token available to the second user; and (f) providing the utilizing transfer token to the second user.

According to still another aspect of the present invention, a computer readable medium recording thereon a program for enabling a computer to execute a method for transferring authority from a first user to a second user, the method for transferring authority including: (a) providing a transfer token to transfer a token from the first user to a third party; (b) releasing the transfer token; (c) providing a utilizing transfer token, the utilizing transfer token including a class of services for the first user; (d) receiving a request to obtain the transfer token released in step (b) from the second user; (e) providing the utilizing transfer token, the utilizing transfer token making the transfer token available to the second user; and (f) providing the utilizing transfer token to the second user.

### BRIEF DESCRIPTION OF THE DRAWINGS

Other features and advantages of the invention will be made more apparent by the following detailed description and the accompanying drawings, wherein:

FIG. 1 is a first block diagram illustrating a system for transferring authority according to an exemplary embodiment of the present invention;

FIG. 2 is a second block diagram illustrating the system for transferring authority according to the exemplary embodiment of the present invention;

FIG. 3 is a diagram illustrating a system configuration example of the system for transferring authority according to the exemplary embodiment of the present invention;

FIG. 4 is a diagram illustrating an internal configuration example of respective devices of the system for transferring authority according to the exemplary embodiment of the present invention;

FIG. 5 is a first sequence chart illustrating a processing operation of the system for transferring authority according to the exemplary embodiment of the present invention;

FIG. 6 is a second sequence chart illustrating a processing operation of the system for transferring authority according to the exemplary embodiment of the present invention;

FIG. 7 is a table illustrating a table configuration example of content management unit (S13) according to the exemplary embodiment of the present invention;

FIG. 8 is a table illustrating a table configuration example of content utilizing condition management unit (S11) according to the exemplary embodiment of the present invention;

FIG. 9 is a table illustrating a table configuration example of service utilizing condition receiving unit (240) according to the exemplary embodiment of the present invention;

FIG. 10 is a table illustrating a table configuration example of user management DB (110) according to the exemplary embodiment of the present invention, in which “user IDs” and “user attribute information” are registered;

FIG. 11 is another table illustrating the table configuration example of user management DB (110) according to the exemplary embodiment of the present invention, in which “content IDs” for user (U1) and “tokens” provided to user (U1) are registered;

FIG. 12 is still another table illustrating the table configuration example of user management DB (110) according to the exemplary embodiment of the present invention, in which “transfer tokens” provided to user (U1) are registered;

FIG. 13 is still another table illustrating the table configuration example of user management DB (110) according to the exemplary embodiment of the present invention, in which “tokens” corresponding to the “content IDs” of the “transfer tokens” provided to user (U1) are managed in association with “user IDn”;

FIG. 14 is still another table illustrating the table configuration example of user management DB (110) according to the exemplary embodiment of the present invention, in which a “utilizing transfer token” provided to “user (Un)” is registered;

FIG. 15 is a table illustrating a table configuration example of communication management unit (301) according to the exemplary embodiment of the present invention; and

FIG. 16 is a diagram illustrating a token transfer method related to the present invention.

In the drawings, the same reference numerals represent the same structural elements.

### DETAILED DESCRIPTION OF THE PREFERRED EMBODIMENT

A first embodiment of the present invention will be described in detail below.

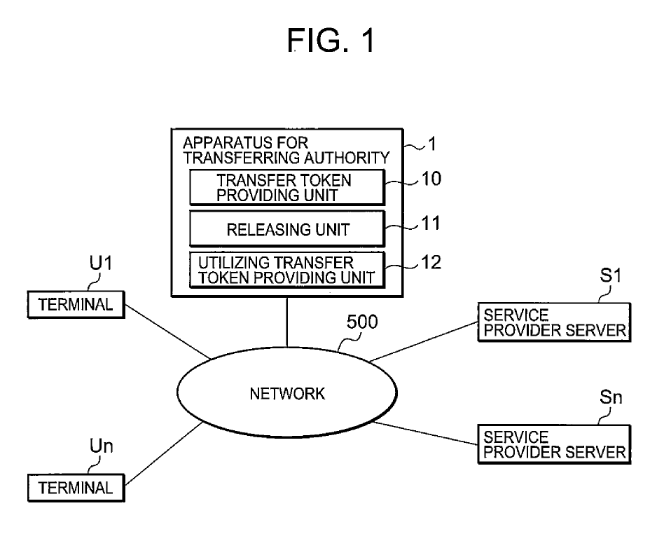

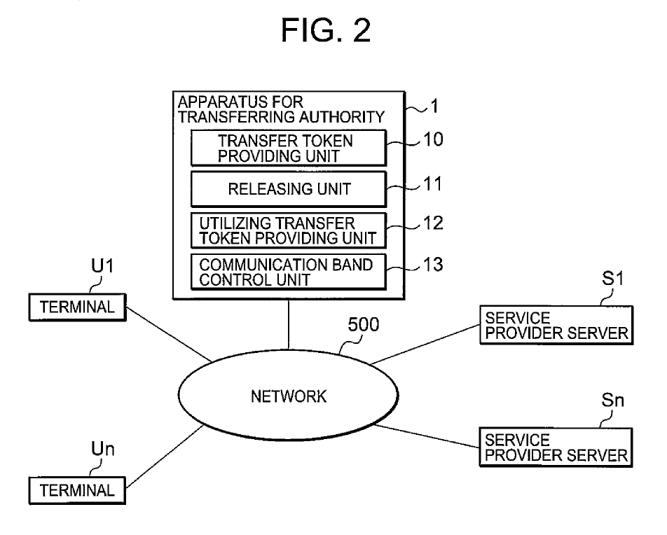

First, referring to FIGS. 1 and 2, a system for transferring authority according to the exemplary embodiment is outlined.

As illustrated in FIG. 1, the system for transferring authority according to the exemplary embodiment includes first terminal (U1) used by a first user, second terminal (Un) used by a second user, and apparatus for transferring authority 1 for transferring a token from the first user to the second user. The token is used to utilize various services provided by service provider servers (S1 to Sn: n is any integer). Apparatus for transferring authority 1 according to the exemplary embodiment includes transfer token providing unit 10, releasing unit 11, and utilizing transfer token providing unit 12.

Transfer token providing unit 10 provides, based on a request from first terminal (U1), a transfer token to transfer a token of the first user to a third party. Releasing unit 11 releases the transfer token provided by transfer token providing unit 10. Utilizing transfer token providing unit 12 provides a utilizing transfer token. If a request to obtain the transfer token released by releasing unit 11 is received from second terminal (Un), utilizing transfer token providing unit 12 provides the utilizing transfer token to make the requested transfer token available to the second user. Then, utilizing transfer token providing unit 12 provides the utilizing transfer token to the second user.

The system for transferring authority according to the exemplary embodiment has a configuration as illustrated in FIG. 1. First, transfer token providing unit 10 provides, based on the request from first terminal (U1), the transfer token to transfer the token of the first user to a third party. Then, releasing unit 11 releases the transfer token provided by transfer token providing unit 10. Subsequently, utilizing transfer token providing unit 12 receives the request to obtain the transfer token released by releasing unit 11 from second terminal (Un). If the request is received, utilizing transfer token providing unit 12 provides the utilizing transfer token to make the requested transfer token available to the second user. Then, utilizing transfer token providing unit 12 provides the utilizing transfer token to the second user. Note that utilizing transfer token providing unit 12 in the exemplary embodiment provides the utilizing transfer token at least including a class of services for the first user.

In this manner, the second user obtains the utilizing transfer token at least including the class of services for the first user. Therefore, when utilizing the utilizing transfer token obtained from the first user, the second user can utilize the utilizing transfer token in the class of the first user.

As illustrated in FIG. 2, apparatus for transferring authority 1 according to the exemplary embodiment further includes communication band control unit 13. Communication band control unit 13 controls, when the second user utilizes the utilizing transfer token, a communication band based on the class included in the utilizing transfer token. In this manner, apparatus for transferring authority 1 controls, when the second user utilizes the utilizing transfer token obtained from the first user, the communication band based on the class included in the utilizing transfer token. Therefore, the second user can utilize the utilizing transfer token in the communication band corresponding to the class included in the utilizing transfer token. Hereinafter, the system for transferring authority according to the exemplary embodiment is described in detail with reference to the attached drawings.

### First Embodiment

### <Configuration of System for Transferring Authority>

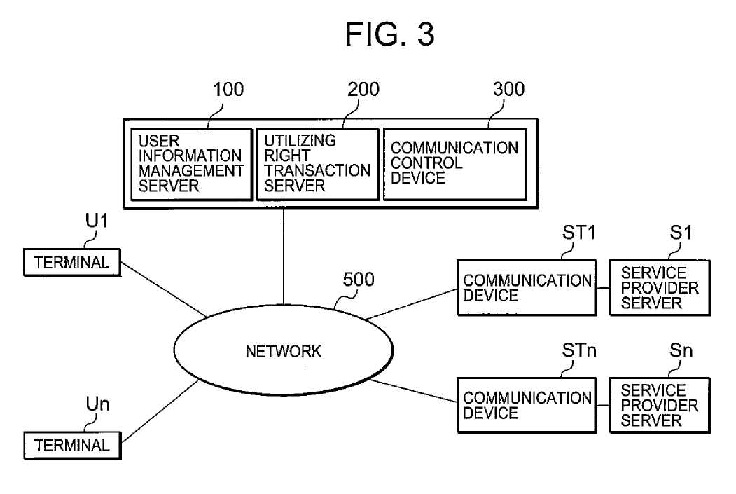

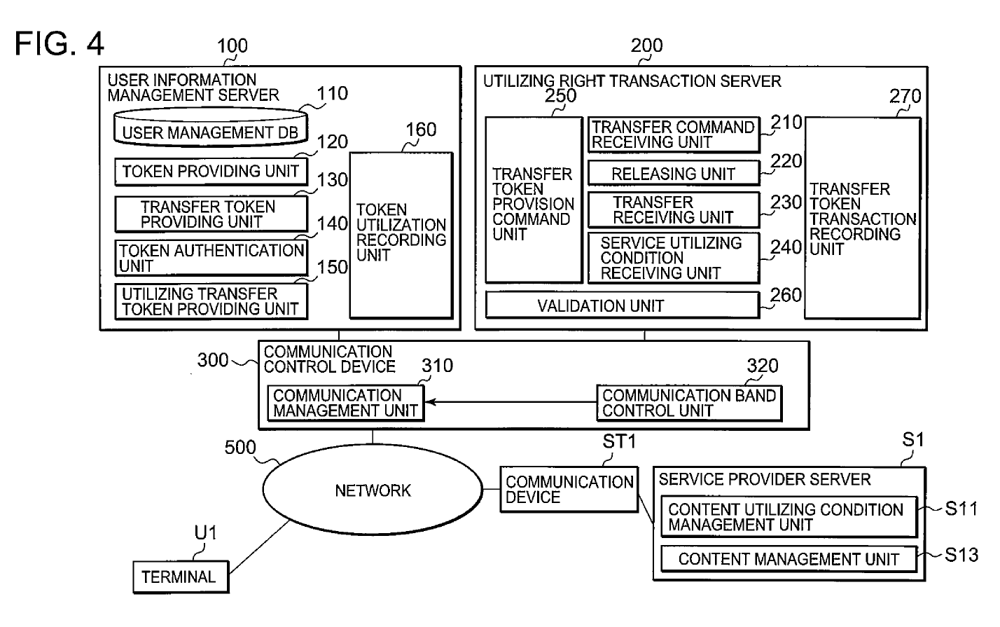

FIGS. 3 and 4 each illustrate a configuration of the system for transferring authority according to the exemplary embodiment. FIG. 3 illustrates an example of the system for transferring authority according to the exemplary embodiment. FIG. 4 illustrates an internal configuration example of respective devices constituting the system for transferring authority according to the exemplary embodiment. The system for transferring authority according to the exemplary embodiment includes terminals (U1 to Un: n is any integer), user information management server 100, utilizing right transaction server 200, communication control device 300, communication devices ST1 to STn (n is any integer), and service provider servers (S1 to Sn: n is any integer). Note that network 500 constituting the system for transferring authority according to the exemplary embodiment can adopt various communication forms, wired or wireless, as long as information can be communicated between the respective devices.

### <Terminals: U1 to Un>

Terminals (U1 to Un) are communication devices used by users U1 to Un. Note that various pieces of equipment can be applied for terminals (U1 to Un) as long as the pieces of equipment can communicate information. For example, a PC, a cell phone, or the like can be applied.

### <Service Provider Servers: S1 to Sn>

Service provider servers (S1 to Sn) are information processing devices used by service providers S1 to Sn for providing various services. Services mean contents such as audio, images, streaming, movie and the like. Note that various pieces of equipment can be applied for service provider servers (S1 to Sn) as long as the pieces of equipment can provide various services. As illustrated in FIG. 4, each of service provider servers (S1 to Sn) includes content utilizing condition management unit S11 and content management unit S13. Content utilizing condition management unit S11 manages conditions for utilizing respective contents (content utilizing conditions) Content management unit S13 manages various contents to be provided to users U1 to Un.

### <Communication Devices: ST1 to STn>

Communication devices ST1 to STn control communication bands between terminals (U1 to Un) and service provider servers (S1 to Sn), respectively.

### <User Information Management Server: 100>

User information management server 100 is an information processing device for managing user attribute information on users U1 to Un. Note that the user attribute information includes, for example, name, address, age, telephone number, and e-mail address of each of users U1 to Un. As illustrated in FIG. 4, user information management server 100 according to the exemplary embodiment includes user management DB 110, token providing unit 120, transfer token providing unit 130, token authentication unit 140, utilizing transfer token providing unit 150, and token utilization recording unit 160,

User management DB 110 manages user attribute information (name, address, age, telephone number, etc. of users) and user IDs used when utilizing a service, of users U1 to Un. Note that the user IDs, are information for identifying users. Token providing unit 120 provides utilizing authority (token) that is required when a user utilizes various services. Transfer token providing unit 130 provides a transfer token that is required when the token provided by token providing unit 120 is transferred to a third party. Utilizing transfer token providing unit 150 provides a utilizing transfer token to make the transfer token provided by transfer token providing unit 130 available to the third party. Token authentication unit 140 validates the token and the utilizing transfer token. Token utilization recording unit 160 records a utilization history of the token and the utilizing transfer token.

### <Utilizing Right Transaction Server: 200>

Utilizing right transaction server 200 is a device for making transaction of a transfer token among users U1 to Un. As illustrated in FIG. 4, utilizing right transaction server 200 according to the exemplary embodiment includes transfer command receiving unit 210, releasing unit 220, transfer receiving unit 230, service utilizing condition receiving unit 240, transfer token provision command unit 250, validation unit 260, and transfer token transaction recording unit 270.

Transfer command receiving unit 210 receives a command to record a token transfer condition. Releasing unit 220 releases the transfer token and the token transfer condition to a third party. Transfer receiving unit 230 receives an application to utilize the utilizing transfer token. Service utilizing condition receiving unit 240 manages conditions for utilizing contents provided by service providers S1 to Sn (content utilizing conditions). Transfer token provision command unit 250 commands user information management server 100 to provide a utilizing transfer token when a token transfer condition is agreed between users. Validation unit 260 requests user information management server 100 to validate the token and the utilizing transfer token. Transfer token transaction recording unit 270 records a transaction history of the transfer token among users U1 to Un.

### <Communication Control Device: 300>

Communication control device 300 controls communication between terminals (U1 to Un) and service provider servers (S1 to Sn). Communication control device 300 according to the exemplary embodiment includes communication management unit 310 and communication band control unit 320.

Communication management unit 310 manages communication devices ST1 to STn to which service provider servers (S1 to Sn) are connected. Communication band control unit 320 controls communication bands for communication devices ST1 to STn.

### <Processing Operations in System for Transferring Authority>

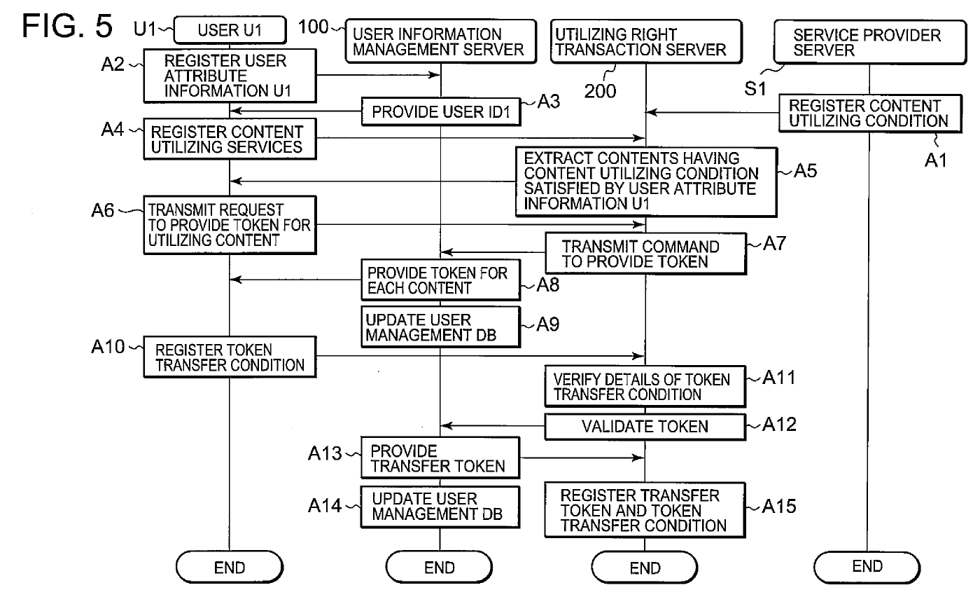

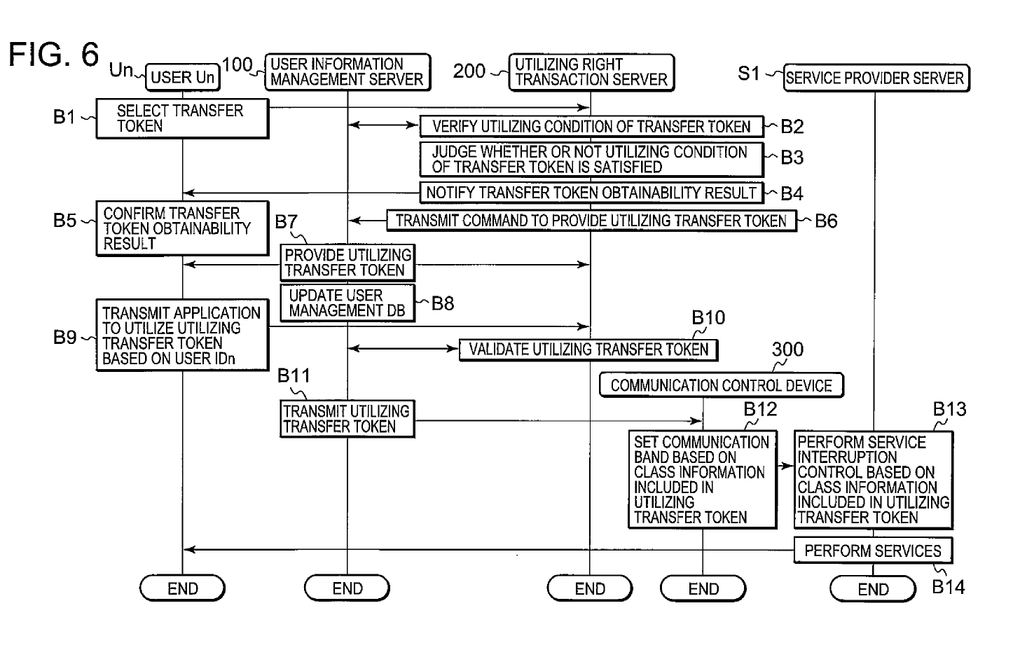

FIGS. 5 and 6 illustrate processing operations in the system for transferring authority according to the exemplary embodiment. Of the figures, FIG. 5 illustrates a processing operation performed in a case where user U1 transfers authority (token) to utilize a content to a third party. FIG. 6 illustrates a processing operation performed when user Un utilizes the authority (transfer token) to utilize the content that has been transferred in the processing operation of FIG. 5.

### <Processing Operation Performed in the Case Where Authority (Token) to Utilize Content is Transferred to Third Party>

First, in FIG. 5, the following processing operation is performed in the case where user U1 transfers the authority (token) to utilize the content to the third party. Service provider S1 registers a content to be provided to users U1 to Un with content management unit S13 of service provider server (S1), and registers a condition for utilizing the content (content utilizing condition) with content utilizing condition management unit S11. The content utilizing condition includes, for example, a period or ages permitted to utilize the content, and information on pieces of equipment with which the content can be used. Note that any condition can be applied for the content utilizing condition as long as the condition can control utilization of the content.

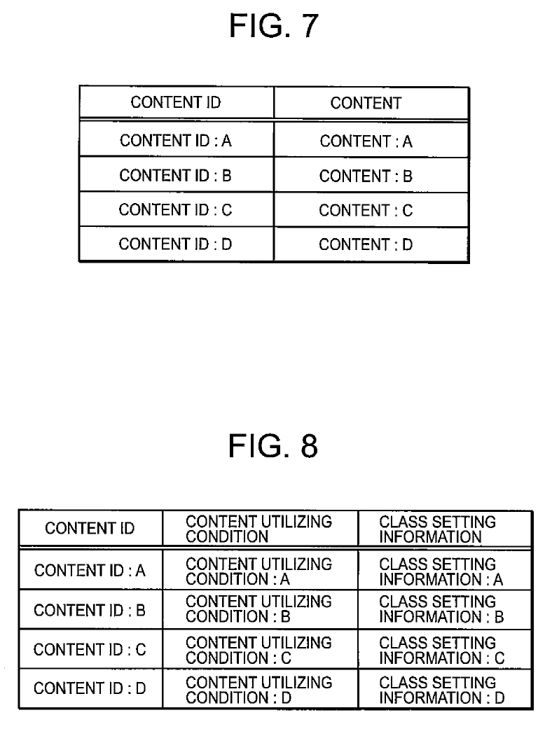

Content management unit 313 of service provider server (S1) according to the exemplary embodiment manages, as illustrated in FIG. 7, for example, “contents” in association with “content IDs”. Further, content utilizing condition management unit S11 manages, as illustrated in FIG. 8, for example, “content utilizing conditions” and “class setting information.” in association with “content IDs”. The “content IDs” are used to identify the contents. The “class setting information” is used to set service utilizing ranges for users in utilizing the contents. According to this “class setting information”, for example, various services of a content can be utilized in class 1, and only specific services of the content can be utilized in class 5. Note that the “class setting information” can adopt various conditions as long as the “class setting information” can set the service utilizing range in utilizing the content. Then, service provider server (S1) registers information managed by content utilizing condition management unit S11 as illustrated in FIG. 8 with service utilizing condition receiving unit 240 in association with a “service provider server ID” (Step A1)

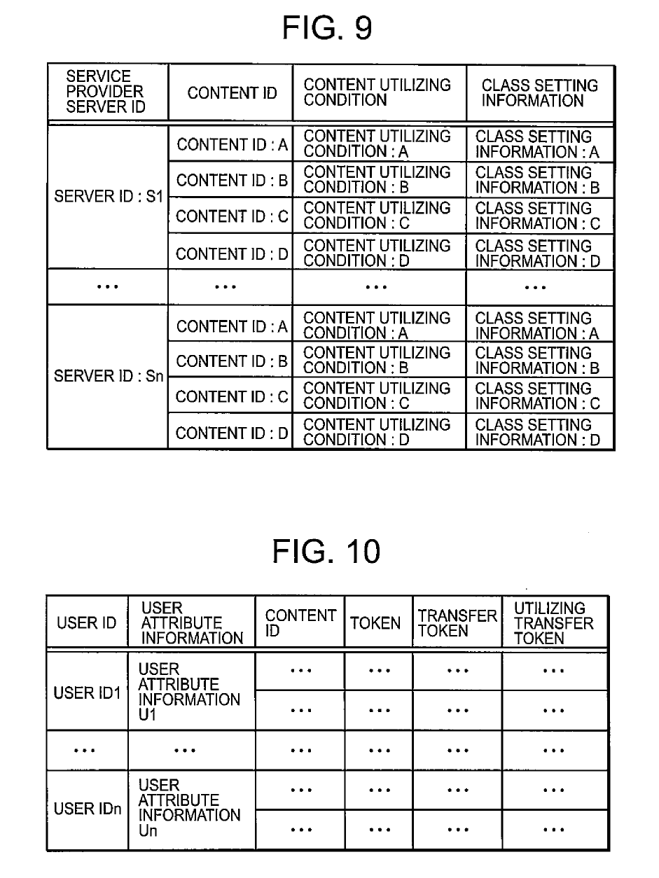

In this manner, service utilizing condition receiving unit 240 can manage, as illustrated in FIG. 9, for example, the “content IDs”, the “content utilizing conditions”, and the “class setting information” in association with “service provider server IDs”. The “service provider server IDs” are used to identify service provider servers (S1 to Sn).

Subsequently, user U1 operates terminal (U1) to access user information management server 100. Then, user U1 registers “user attribute information U1” on user U1 (Step A2). “User attribute information U1” includes, for example, name, address, age, phone number, e-mail address, and the like of user U1. Note that any information can be registered as the user attribute information as long as user attributes can be identified with the “user attribute information”.

Upon receiving registration of “user attribute information U1” of user U1, user information management server 100 provides “user ID1” of user U1 and notifies user U1 of the “user ID1” (Step A3). In this manner, user U1 can obtain “user ID1” provided by user information management server 100.

In this case, user information management server 100 associates “user ID1” provided to user U1 with “user attribute information U1” of user U1 to be registered in user management DB 110. In this manner, user management DB 110 manages, as illustrated in FIG. 10, “user ID1” in association with “user attribute information U1”. “User ID1” is used to identify user U1.

Subsequently, user U1 operates terminal (U1) to access utilizing right transaction server 200. Then, user U1 registers utilizing services to utilize various contents provided by service providers S1 to Sn (Step A4). At this time, terminal (U1) transmits “user ID1” of user U1.

Upon receiving the registration of the utilizing services, utilizing right transaction server 200 refers to user management DB 110 of user information management server 100 to obtain “user attribute information U1” of user U1 based on “user ID1” of user U1.

Subsequently, utilizing right transaction server 200 compares “user attribute information U1” of user U1 and the is “content utilizing conditions” (see FIG. 9) of the various contents managed by service utilizing condition receiving unit 240. Utilizing right transaction server 200 extracts a “content ID” having the “content utilizing condition” satisfied by “user attribute information U1” of user U1. Then, utilizing right transaction server 200 presents the extracted “content ID” and its “class setting information” on terminal (U1) (Step A5).

As an example, the following conditions are assumed. In service utilizing condition receiving unit 240, “content utilizing condition: A” of “content ID: A” includes information “aged 20 or older”. Similarly, “content utilizing condition: B” of “content ID: B” includes information “all ages”. In this case, when “user attribute information U1” includes information “aged 18”, “user attribute information U1” does not satisfy “content utilizing condition: A” of “content ID: A”. On the other hand, “user attribute information U1” satisfies “content utilizing condition: B” of “content ID: B”. In this case, utilizing right transaction server 200 extracts “content ID: B” having “content utilizing condition: B” satisfied by “user attribute information U1”, and presents the extracted “content ID: B” and its “class setting information: B” on terminal (U1).

Subsequently, user U1 operates terminal (U1) to select at least one “content ID” for user U1 from among “content IDs” presented on terminal (U1). Further, user U1 operates terminal (U1) to set “class information” used to determine a service utilizing range in utilizing a content based on “class setting information” of the “content ID”. Then, user U1 operates terminal (U1) to transmit a request to provide a token for utilizing the “content ID” to utilizing right transaction server 200 (Step A6). At this time, terminal (U1) transmits “user ID1” of user U1 and “class information” for each content to utilizing right transaction server 200.

Note that for a method of setting the above-mentioned “class information”, a method in which, when a range of classes 1 to 5 is set as the “class setting information”, user U1 operates terminal (U1),to select a class from among classes 1 to 5 can be applied. In this manner, user U1 can decide a class of services in utilizing the content.

Upon receiving the request to provide the token, utilizing right transaction server 200 transmits a command to provide the token to user information management server 100 (Step A7) At this time, utilizing right transaction server 200 transmits “user ID1” of user U1 and “class information” for each content to user information management server 100.

When user information management server 100 receives the command to provide the token, token providing unit 120 provides a token for each content based on information of “user ID1” of user U1 and the “class information” for each content (Step A8). Note that token providing unit 120 according to the exemplary embodiment provides the token including the “class information”. In this manner, when user U1 utilizes various services of the content using the token, user U1 can utilize services corresponding to the “class information” included in the token.

Subsequently, token providing unit 120 notifies user U1 of the token. As a method of notifying user U1 of the token, for example, a method of notifying-terminal (U1) of user U1 based on an e-mail address included in “user attribute information U1” managed in user management DB 110 can be employed. Alternatively, a method of registering the token in association with “user ID1” in user management DB 110 and notifying user U1 of the token associated with “user ID1” when user U1 accesses user information management server 100. In this manner, user U1 can confirm the token for each content for user U1.

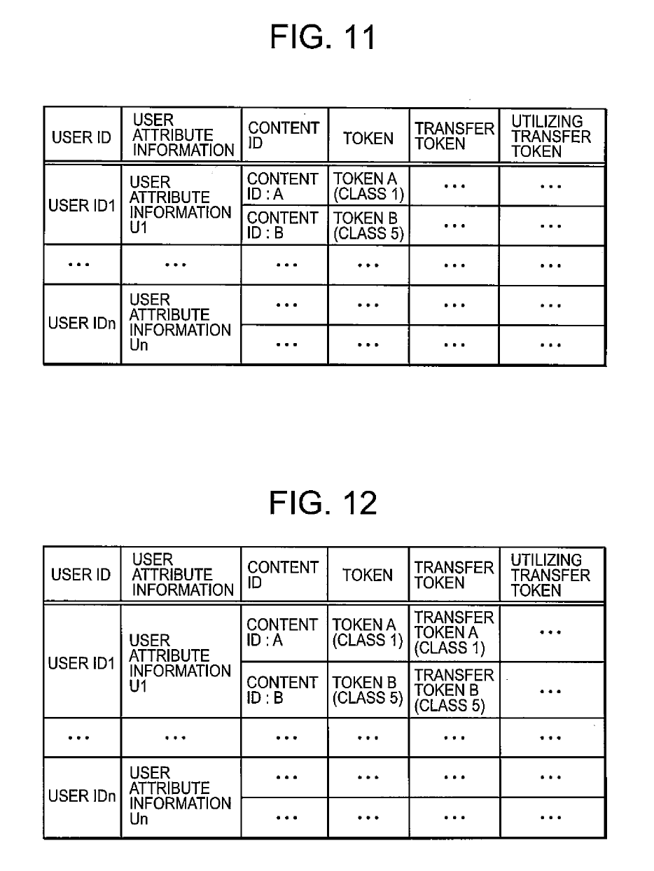

Subsequently, user information management server 100 associates the “token” provided by token providing unit 120 with the “content ID” of the “token”. Then, user information management server 100 registers the “token” and the “content ID” in user management DB 110 and, as illustrated in FIG. 11, updates information on user U1 (user ID1) managed in user management DB 110 (Step A9).

In this manner, as illustrated in FIG. 11, user information management server 100 can manage information of the “token” for each content provided by token providing unit 120 to user U1, based on the “user ID”.

FIG. 11 illustrates that “token A” of “content ID: A” and “token B” of “content ID: B” are managed in association with “user ID1” in user management DB 110. Note that “token A” includes class 1 as the class information. Similarly, “token B” includes class 5 as the class information. In the exemplary embodiment, service utilizing ranges according to classes are defined as class 1 (large service utilizing range)>class 5 (small service utilizing range. Therefore, class 1 is defined so that various services of the content can be utilized, and class 5 is defied so that only specific services of the content can be utilized.

Subsequently, user U1 operates terminal (U1) to create a transfer condition (token transfer condition). Specifically, user U1 creates, based on a “token” managed in association with “user ID1” in user management DB 110, a transfer condition for transferring the “token” to a third party. Then, terminal (U1) transmits a command to register the token transfer condition to utilizing right transaction server 200 (Step A10) The token transfer condition includes a transfer period during which the token is transferred to the third party, the number of times the third party can utilize the token, and an attribute condition (age, region, etc.) of the third party to whom the token is to be transferred.

Note that the “token” managed in user management DB 110 is updated based on the utilization history recorded in token utilization recording unit 160. Therefore, user U1 creates the transfer condition (token transfer condition) for transferring the “token” to the third party based on the “token” currently available to user U1.

When utilizing right transaction server 200 receives the command to register the token transfer condition, transfer command receiving unit 210 verifies details of the token transfer condition to be registered based on the received command (Step A11).

Transfer command receiving unit 210 verifies the token transfer condition and the content utilizing condition managed by service utilizing condition receiving unit 240 for a match. When the token transfer condition and the content utilizing condition corresponding to the token do match, transfer command receiving unit 210 notifies validation unit 260 of a request to inquire validity of the token.

As an example, the token transfer condition and the content utilizing condition corresponding to the token are verified for a match as follows. It is assumed that the content utilizing condition includes information “aged 20 or older” and that the token transfer condition includes information “aged 18 or older”. In this case, the token transfer condition does not satisfy the content utilizing condition, and transfer command receiving unit 210 judges that the token transfer condition and content utilizing condition do not match. Thus, transfer command receiving unit 210 notifies user U1 of the mismatch and controls utilizing right transaction server 200 not to register the token transfer condition.

As another example, it is assumed that the content utilizing condition includes information “all ages” and that the token transfer condition includes information “aged 18 or older”. In this case, the token transfer condition satisfies the content utilizing condition, and transfer command receiving unit 210 judges that the token transfer condition and the content utilizing condition do match. In this case, transfer command receiving unit 210 controls utilizing right transaction server 200 to notify validation unit 260 of the request to inquire validity of the token.

Upon receiving the request to inquire validity of the token, validation unit 260 inquires of user information management server 100 validity of the token of user U1 received by transfer command receiving unit 210 in Step A11 to validate the token of user U1 (Step A12). At this time, validation unit 260 transmits the token transfer condition and “user ID1” of user U1 to user information management server 100.

When user information management server 100 receives the inquiry about the validity of the token, token authentication unit 140 refers to user management DB 110 based on “user ID1” of user U1 to validate the token of user U1.

When the “token” of user U1 in the received inquiry is managed in association with “user ID1” in user management DB 110, token authentication unit 140 judges that the token is valid. In this case, token authentication unit 140 notifies transfer token providing unit 130 of a command to provide a transfer token for the “token” of user U1 in the received inquiry.

Upon receiving the command to provide the transfer token for the “token” of user U1, transfer token providing unit 130 provides the transfer token for the “token” of user U1 based on the information of the “token” of user U1 and the token transfer condition (Step A13)

As an example, it is assumed that the “token” of user U1 includes the class information for class 1. Further, the token transfer condition is set so that a third party can utilize the content up to five times. In this case, transfer token providing unit 130 provides the transfer token with which the third party can utilize the content up to five times in class 1. In this manner, transfer token providing unit 130 provides the transfer token including the class information.

Subsequently, user information management server 100 registers the “transfer token” provided by transfer token providing unit 130 in association with a “content ID” of the “transfer token” in user management DB 110. User information management server 100 updates information on user U1 (user ID1) as illustrated in FIG. 12 (Step A14). In this manner, user information management server 100 can manage, as illustrated in FIG. 12, the “transfer token” provided by transfer token providing unit 130 in association with the “content ID” of the “transfer token” in user management DB 110. FIG. 12 illustrates that “transfer token A” of “token A” is managed in association with “content ID: A”, and that “transfer token B” of “token B” is managed in association with “content ID: B”. Note that, as illustrated in FIG. 12, “transfer token A” includes class 1 in “token A” as the class information, and “transfer token B” includes class 5 in “token B” as the class information.

Subsequently, transfer token providing unit 130 notifies user U1 of the transfer token. In this manner, user U1 can confirm the provision of the transfer token.

At this time, user information management server 100 notifies utilizing right transaction server 200 of the “transfer token” of user U1 provided by transfer token providing unit 130 in Step A13. Upon being notified of the “transfer token” of user U1, utilizing right transaction server 200 judges that the token of user U1 is valid. Utilizing right transaction server 200 registers the.“transfer token” of user U1 and its “token transfer condition” with releasing unit 220 (Step A15)

In this manner, utilizing right transaction server 200 can release the “transfer token” and the “token transfer condition” registered with releasing unit 220 to a third party.

Note that a releasing method for the “transfer token” and the “token transfer condition” is not specifically limited, and any releasing method can be adopted. For example, a method of releasing on a special site or the like can be adopted. As an alternative configuration example, user U1 may set the releasing method for the transfer token.

### <Processing Operation Performed When User Un Utilizes Transfer Token That Has Been Transferred>

Next, referring to FIG. 6, a processing operation performed when user Un utilizes the transfer token released to the third party in the processing operation of FIG. 5 is described hereinbelow. It is assumed that user Un, who operates terminal (Un), has registered “user attribute information Un” in user management DB 110 and has obtained “user IDn” provided by user information management server 100. Note that “user IDn” is identification information for identifying user Un.

First, user Un operates terminal (Un) to access utilizing right transaction server 200 and select a “transfer token” released by releasing unit 220 of utilizing right transaction server 200 (Step B1). At this time, terminal (Un) transmits “user IDn” of user Un to utilizing right transaction server 200.

When an operation to select the “transfer token” is performed, utilizing right transaction server 200 refers to user management DB 110 of user information management server 100 to obtain “user attribute information Un” of user Un based on “user IDn” of user Un. Then, utilizing right transaction server 200 compares “user attribute information Un” of user Un and the “content utilizing condition” managed by service utilizing condition receiving unit 240. Utilizing right transaction server 200 verifies whether or not “user attribute information Un” of user Un satisfies the “content utilizing condition” of the “transfer token” selected by user Un in Step B1 (Step B2).

Utilizing right transact-on server 200 also compares “user attribute information Un” of user Un and the “token transfer condition” registered with releasing unit 220. Utilizing right transaction server 200 verifies whether or not “user attribute information Un” of user Un satisfies the “token transfer condition”. (Step B2).

Subsequently, utilizing right transaction server 200 judges whether or not “user attribute information Un” of user Un satisfies the “content utilizing condition” of the “transfer token” selected by user Un in Step B1 and the “token transfer condition” (Step B3). Then, utilizing right transaction server 200 notifies user Un of a result of the judgment on whether or not user Un can obtain the “transfer token” selected by user Un (transfer token obtainability result) (Step B4). In this manner, user Un can confirm the transfer token obtainability result of the “transfer token” selected by user Un (Step B5) When it is judged that user Un can obtain the “transfer token” selected by user Un, transfer token provision command unit 250 transmits a command to provide the utilizing transfer token to make the “transfer token” available to user Un to user information management server 100 (Step B6). At this time, transfer token provision command unit 250 transmits information on the “transfer token” selected by user Un and information on “user IDn” to user information management server 100.

When user information management server 100 receives the command to provide the utilizing transfer token, utilizing transfer token providing unit 150 provides the “utilizing transfer token” to make the “transfer token” selected by user Unavailable to user Un based on the information on the “transfer token” selected by user Un and the information on “user IDn” (Step B7).

In this case, first, utilizing transfer token providing unit 150 refers to user management DB 110 based on “user IDn”. Utilizing transfer token providing unit 150 verifies whether or not a “token” corresponding to a “content ID” of the “transfer token” is managed in association with “user IDn” in user management DB 110. When utilizing transfer token providing unit 150 judges that the “token” corresponding to the “content ID” of the “transfer token” is not managed in association with “user IDn” in user management DB 110, utilizing transfer token providing unit 150 judges that user Un utilizes services of the “transfer token” for the first time. In this case, utilizing transfer token providing unit 150 provides a “utilizing transfer token” including class information included in the “transfer token”.

In a case of, for example, user management DB 110 illustrated in FIG. 12, “token A” corresponding to “content ID: A” of “transfer token A” is not managed in association with “user IDn”. Therefore, it is judged that user Un utilizes services of “transfer token A” for the first time. In this case, utilizing transfer token providing unit 150 provides the “utilizing transfer token” including class information of class 1 included in “transfer token A”.

On the other hand, when the “token” corresponding to the “content ID” of the “transfer token” is managed in association with “user IDn” in user management DB 110, utilizing transfer token providing unit 150 judges that services of the “transfer token” are already available to user Un. In this case, utilizing transfer token providing unit 150 compares the class information included in the “token” associated with “user IDn” and the class information included in the “transfer token” to provide the “utilizing transfer token” including the class information of the higher class.

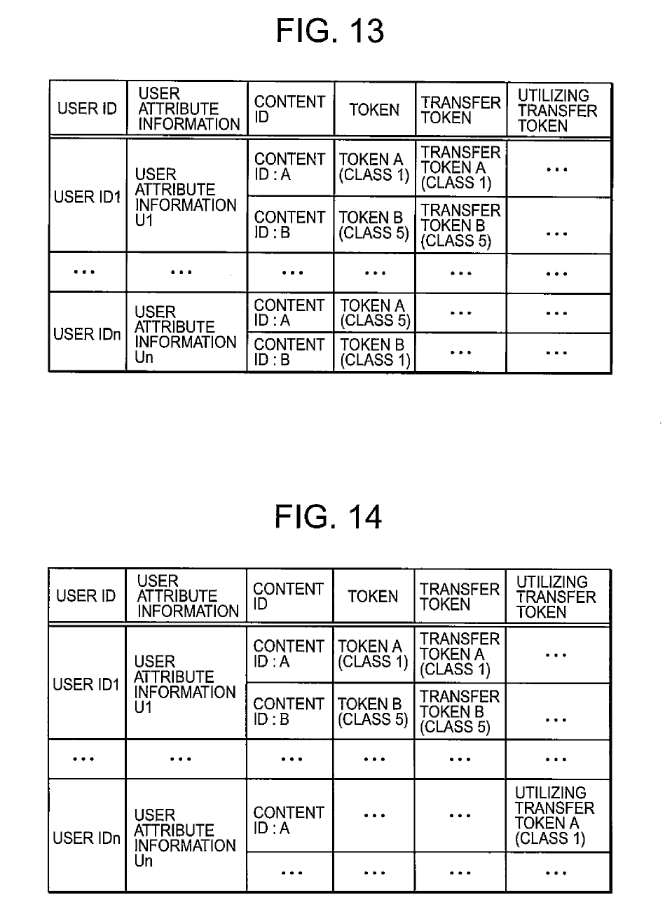

In a case of, for example, user management DB 110 illustrated in FIG. 13, “token A” corresponding to “content ID: A” of “transfer token A” is managed in association with “user IDn” Therefore, it is judged that services of “transfer token A” are already available to user Un. In this case, utilizing transfer token providing unit 150 compares the class information of class 5 included in “token A” associated with “user IDn” with the class information of class 1 included in “transfer token A” to provide “utilizing transfer token A” including the class information of class 1 which is the higher class. In this manner, even if user Un can utilize services of a content of “token A” in class 5, providing “utilizing transfer token A” based on class 1 of “transfer token A” enables user Un to utilize the services of the content of the “transfer token A” in class 1.

Further, in the case of user management DB 110 illustrated in FIG. 13, “token B” corresponding to “content ID: B” of “transfer token B” is managed in association with “user IDn”. Therefore, it is judged that services of “transfer token B” are already available to user Un. In this case, utilizing transfer token providing unit 150 compares the class information of class 1 included in “token B” associated with “user IDn” with the class information of class 5 included in “transfer token B” to provide “utilizing transfer token B” including the class information of class 1 which is the higher class. In this manner, by providing “utilizing transfer token B” based on class 1 of “token B” already held by user Un, user Un can utilize the services of the content of the “transfer token B” in class

Subsequently, utilizing transfer token providing unit 150 notifies user Un of the “utilizing transfer token”. Note that as a method of notifying user Un of the “utilizing transfer token”, a method of notifying terminal (Un) of user Un of the token based on an e-mail address included in “user attribute information Un” managed in user management DB 110 may be employed. As an alternative method, a method of registering the “utilizing transfer token” in association with “user IDn” in user management DB 110 and notifying user Un of the “utilizing transfer token” associated with “user IDn” when user Un accesses user information management server 100 may be employed. In this manner, user Un can confirm the “utilizing transfer token” provided by utilizing transfer token providing unit 150.

At this time, user information management server 100 notifies user Un, who is the transfer source, of information indicating that the “utilizing transfer token” has been provided. In this manner, user U1, who is the transfer source, can confirm that the “utilizing transfer token” has been provided.

Further, user information management server 100 notifies utilizing right transaction server 200 of the “utilizing transfer token” and registers the “utilizing transfer token” with releasing unit 220. Then, utilizing right transaction server 200 releases, based on the “utilizing transfer token” registered with releasing unit 220, differential information which is obtained by subtracting information of the “utilizing transfer token” from information of the “transfer token” (“transfer token”—“utilizing transfer token”) to the third party.

As an example, the following situation is assumed. The information of the “transfer token” is set so that a third party can utilize the content up to ten times. The information of the “utilizing transfer token” is set so that user Un can utilize the content up to five times. In this case, utilizing right transaction server 200 sets the differential information so that a third party can utilize the content up to five times and releases the differential information to the third party. In this manner, utilizing right transaction server 200 can release only the differential information (“transfer token”—“utilizing transfer token”) that can be transferred to the third party.

At this time, utilizing right transaction server 200 manages information on transaction history of the transfer token performed between users U1 and Un by recording the information in transfer token transaction recording unit 270. In this manner, the system can manage the transaction history of the “transfer token” registered with releasing unit 220 in transfer token transaction recording unit 270.

Subsequently, user information management server 100 registers the “utilizing transfer token” provided by utilizing transfer token providing unit 150 with user management DB 110 in association with the “content ID” of the “utilizing transfer token” and “user IDn”. Then, user information management server 100 updates the information on user Un as illustrated in FIG. 14 (Step B8). FIG. 14 illustrate show “utilizing transfer token A” is managed in association with “content ID: A” and “user IDn” in user information management server 100.

Subsequently, user Un operates terminal (Un) to transmit an application to utilize the “utilizing transfer token” managed in user management DB 110 in association with “user IDn” to utilizing right transaction server 200 (Step B9). At this time, terminal (Un) transmits “user IDn” of user Un to utilizing right transaction server 200.

If utilizing right transaction server 200 receives the application to utilize the “utilizing transfer token” from user Un, transfer receiving unit 230 receives the application to utilize the “utilizing transfer token” of user Un. At the same time, validation unit 260 inquires of user information management server 100 validity of the “utilizing transfer token” of user Un received by transfer receiving unit 230. Then, validation unit 260 validates the “utilizing transfer token” of user Un (Step B10). At this time, validation unit 260 transmits “user IDn” of user Un to user information management server 100.

When user information management server 100 receives the validation of the “utilizing transfer token” of user Un, token authentication unit 140 refers to user management DB 110 to verify the validity of the “utilizing transfer token” of user Un based on “user IDn”. If the “utilizing transfer token” of user Un is managed in association with “user IDn” in user management DB 110, token authentication unit 140 judges that the “utilizing transfer token” of user Un is valid, and transmits the “utilizing transfer token” of user Un to communication control device 300 (Step B11). At this time, when user information management server 100 judges that the “utilizing transfer token” of user Un is valid, user information management server 100 records a utilization history of the “utilizing transfer token” of user Un in token utilization recording unit 160. User information management server 100 also updates the “utilizing transfer token” of user Un managed in user management DB 110.

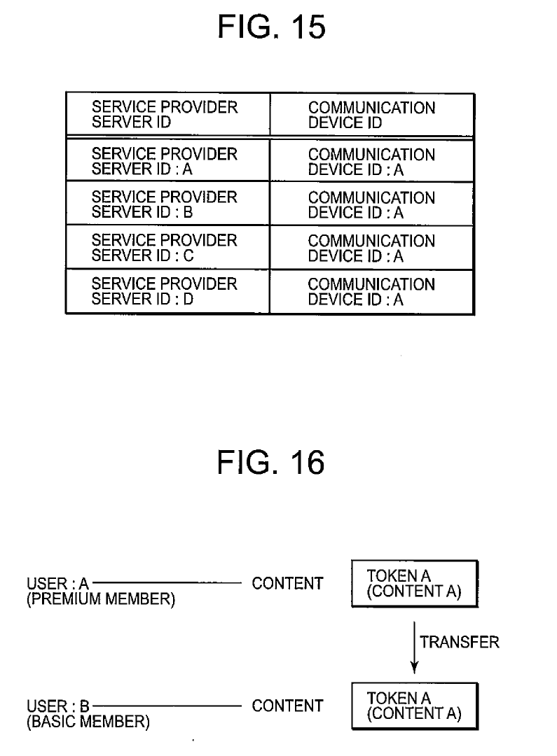

Upon receiving the “utilizing transfer token” of user Un, communication control device 300 refers to service utilizing condition receiving unit 240 based on the “content ID” of the “utilizing transfer token” to specify a “service provider server ID” associated with the “content ID”. In this manner, communication control device 300 can specify service provider server (S1) for utilizing the contents of the “utilizing transfer token”. Then, communication control device 300 refers to communication management unit 310 based on the “service provider server ID” to specify a “communication device ID” associated with the “service provider server ID” as illustrated in FIG. 15. In this manner, communication control device 300 can specify communication device ST1 connected to service provider server (S1). FIG. 15 illustrates a table configuration example of communication management unit 310. FIG. 15 illustrates how “service provider server IDs” are managed in association with “communication device IDs”. In this manner, communication control device 300 can specify which service provider server (S1 to Sn) is connected with which communication device ST1 to STn.

Subsequently, communication band control unit 320 controls communication device ST1 to set a communication band based on the class information included in the “utilizing transfer token” of user Un (step B12).

For example, when the class information included in the “utilizing transfer token” is class 1, communication band control unit 320 preferentially assigns an unused communication band to communication device ST1 to additionally secure a predetermined communication band. Similarly, when the class information is class 5, communication band control unit 320 controls communication device ST1 to secure a preset communication band. In this manner, communication band control unit 320 controls communication device ST1 to have a communication band based on the class information included in the “utilizing transfer token”. Communication band control unit 320 can also control an error correction method, an encryption method, a data compression method, or the like according to the class information included in the “utilizing transfer token”.

Subsequently, communication control device 300 transmits the “utilizing transfer token” of user Un to service provider server (S1) Upon receiving the “utilizing transfer token” of user Un, service provider server (S1) performs service interruption control to provide the content based on the class information included in the “utilizing transfer token” (Step B13). Then, service provider server (S1) provides services of the content corresponding to the “utilizing transfer token” of user Un to user Un (Step B14).

As an example, the following situation is assumed. Service provider server (S1) maintains a list for managing the order of users to be provided the content in time series. Service provider server (S1) registers the place of user Un in the list of users to be provided the content based on the class information included in the “utilizing transfer token” of user Un. In this case, if the class information included in the “utilizing transfer token” is class 1, service provider server (S1) registers user Un at the top of the list of users to be provided the content, so that user Un is given the top priority in providing the content. On the other hand, if the class information is class 5, service provider server (S1) does not perform preferential control and registers user Un at the bottom of the list of users to be provided the content. Then, service provider server (S1) provides, when it is user Un's turn to be provided services of the content, the services of the content according to the class information included in the “utilizing transfer token” of user Un. At this time, communication device ST1 sets the communication band according to the class information included in the “utilizing transfer token”. Therefore, communication device ST1 uses the communication band to deliver the content provided by service provider server (S1) to terminal (Un)

### <Operation and Effects of the Exemplary Embodiment>

As described above, in the system for transferring authority according to the exemplary embodiment, first, upon receiving the request to provide token for utilizing the content from user U1, utilizing right transaction server 200 commands user information management server 100 to provide the token. Upon receiving the command to provide the token, user information management server 100 provides the token and manages the provided “token” in association with “user ID1” in user management DB 110. Note that user information management server 100 provides the token including information on the class of services for user U1. Therefore, user U1 can utilize the services of the content corresponding to the class information included in the “token”.

Further, when utilizing right transaction server 200 receives the command to register the token transfer condition, utilizing right transaction server 200 inquires of user information management server 100 validity of the token of user U1. When user information management server 100 receives the inquiry about the validity of the token, user information management server 100 refers to user management DB 110 to validate the token of user U1. When the token of user U1 is valid, user information management server 100 provides the transfer token to transfer the token from user U1 to the third party. Then, user information management server 100 notifies utilizing right transaction server 200 of the transfer token. Further, user information management server 100 manages the “transfer token” in association with “user ID1” in user management DB 110. When utilizing right transaction server 200 obtains the transfer token from user information management server 100, utilizing right transaction server 200 releases the transfer token to the third party. Note that user information management server 100 in the exemplary embodiment provides the “transfer token” including the class information of the token. Therefore, utilizing right transaction server 200 can transfer the “transfer token” including the class information of the “token” of user U1 to the third party.

When utilizing right transaction server 200 receives the request to obtain the transfer token released to the third party from user Un, utilizing right transaction server 200 commands user information management server 100 to provide the utilizing transfer token to make the transfer token available to user Un. When user information management server 100 receives the command to provide the utilizing transfer token, user information management server 100 provides the utilizing transfer token and manages the provided “utilizing transfer token” in association with “user IDn” in user management DB 110. Note that user information management server 100 in the exemplary embodiment provides the “utilizing transfer token” at least including the class information of the “transfer token”. Therefore, user Un can utilize the services of the content including the class of user U1.

If the services of the “transfer token” are already available to user Un, user information management server 100 according to the exemplary embodiment compares the class of user U1 and the class of user Un. Then, user information management server 100 provides the “utilizing transfer token” including the class based on the comparison result. On the other hand, when user Un utilizes the service of the “transfer token” for the first time, user information management server 100 provides the “utilizing transfer token” including the class of user U1. In the case of providing the “utilizing transfer token” including the class based on the comparison result, when the class of user U1, is higher than the class of user Un, user information management server 100 provides the “utilizing transfer token” including the class of user U1. When the class of user U1 is lower than the class of user Un, user information management server 100 provides the “utilizing transfer token” including the class of user Un. In this manner, when the class of user U1, who is the transfer source, is lower than the class of user Un, who is the transfer destination, user information management server 100 provides the “utilizing transfer token” including the class of user Un of the higher class. Therefore, user Un can utilize the services of the content in the class of user Un, which is higher than the class of user U1.

Subsequently, if utilizing right transaction server 200 receives the application to utilize the utilizing transfer token from user Un, utilizing right transaction server 200 inquires of user information management server 100 validity of the utilizing transfer token of user Un. When user information management server 100 receives the inquiry about the validity of the utilizing transfer token, user information management server 100 refers to user management DB 110 to validate the utilizing transfer token of user Un. When the utilizing transfer token of user Un is valid, user information management server 100 notifies service provider server (S1) of the utilizing transfer token. Upon receiving the utilizing transfer token, service provider server (S1) provides the services corresponding to the class information included in the utilizing transfer token to user Un. In this manner, user Un can utilize the service corresponding to the class information included in the utilizing transfer token.

Further, when user Un utilizes the utilizing transfer token, communication control device 300 according to the exemplary embodiment controls the communication band based on the class included in the utilizing transfer token. In this manner, user Un can utilize various services of the utilizing transfer token in the class included in the utilizing transfer token. Note that the exemplary embodiment described above is a preferred embodiment of the present invention and is not intended to limit the scope of the present invention to the exemplary embodiment described above. Those skilled in the art can make modification or substitution thereto and construct embodiments by applying various changes without departing from the gist of the present invention.

For example,in the exemplary embodiment described above, the “token” is managed in user management DB 110, but the “token” may be managed by terminals (U1 to Un).

Further, the control operations performed by the devices constituting the system for transferring authority according to the exemplary embodiment described above may be performed using hardware, software, or a hybrid configuration thereof.

When performed using software, the processing may be performed by installing a program recorded with a processing sequence to a memory incorporated in dedicated hardware in a computer. Alternatively, the processing may be performed by installing the program to a general-purpose computer that can perform various kinds of processing.

As an example, the program may be previously recorded on a recording medium such as a hard disk or a read only memory (ROM). Alternatively, the program may be temporarily or permanently stored (recorded) on a removable recording medium. Such a removable recording medium may be provided as so-called package software. Examples of the removable recording medium include a floppy (registered trademark) disk, a compact disc read only memory (CD-ROM), a magneto optical (MO) disk, a digital versatile disc (DVD), a magnetic disk, a semiconductor memory, and the like.

Note that the program is installed from such removable recording medium as described above to the computer. Alternatively, the program is wirelessly transferred from a download site to the computer, or wired-transferred to the computer via a network.

The system for transferring authority according to the exemplary embodiment is not only performed in time series according to the processing operations described in the exemplary embodiment, but can also be constructed to be performed in parallel or separately according to the processing capacity of an apparatus that performs the processing or as needed.

Further, the system for transferring authority according to the exemplary embodiment may be constructed to have a configuration of a logical set of a plurality of apparatuses or a configuration in which apparatuses having their own configurations exist in the same housing.

The apparatus, system, method, and program for transferring authority according to the present invention can be applied to a network service in which the token for utilizing various services such as contents are transferred between users.

While this invention has been described in conjunction with the preferred embodiment described above, it will now be possible for those skilled in the art to put this invention into practice in various other manners.

What is claimed is:

1. An apparatus for transferring authority from a first user to a second user, comprising:
a transfer token providing unit for providing a transfer token to transfer a token of said first user to a third party;
a releasing unit for releasing said transfer token; and
a utilizing transfer token providing unit for providing a utilizing transfer token, said utilizing transfer token including a class of services for said first user,
wherein said utilizing transfer token providing unit receives a request to obtain said transfer token released by said releasing unit from said second user, and
wherein said utilizing transfer token providing unit provides said utilizing transfer token to said second user, said utilizing transfer token making said transfer token available to said second user.

2. The apparatus for transferring authority according to claim 1,
wherein said transfer token providing unit provides said transfer token, said transfer token including at least one class of services for said first user, and
wherein said utilizing transfer token providing unit provides said utilizing transfer token based on the class included in said transfer token, said utilizing transfer token including a class of said first user.

3. The apparatus for transferring authority according to claim 1,
wherein said utilizing transfer token providing unit compares the class of said first user with a class of said second user,
wherein said utilizing transfer token providing unit provides the utilizing transfer token including a class based on a result of said comparing, and
wherein said utilizing transfer token providing unit provides said utilizing transfer token including the class of said first user when said second user utilizes the service of said transfer token for the first time.

4. The apparatus for transferring authority according to claim 3,
wherein said utilizing transfer token providing unit provides said utilizing transfer token including the class of said first user when the class of said first user is higher than the class of said second user, and
wherein said utilizing transfer token providing unit provides said utilizing transfer token including the class of said second user when the class of said first user is lower than the class of said second user.

5. The apparatus for transferring authority according to claim 1, further comprising a communication band control unit for controlling a communication band based on the class included in said utilizing transfer token.

6. The apparatus for transferring authority according to claim 5,
wherein said service is a content delivery service,
wherein said communication band control unit controls the communication band based on the class included in said utilizing transfer token, and
wherein said communication band control unit delivers contents based on said controlled communication band.

7. A system for transferring authority from-a first user to a second user, comprising:
an apparatus for transferring authority;
a first terminal; and
a second terminal,
wherein said apparatus comprises a transfer token providing unit for providing a transfer token to transfer a token of said first user to a third party based on a request from said first terminal, a releasing unit for releasing said transfer token, and a utilizing transfer token providing unit for providing a utilizing transfer token, said utilizing transfer token including a class of services for said first user,
wherein said utilizing transfer token providing unit receives a request to obtain said transfer token released by said releasing unit from said second terminal,
wherein said utilizing transfer token providing unit provides said utilizing transfer token, said utilizing transfer token making said transfer token available to said second user, and
wherein said utilizing transfer token providing unit provides said utilizing transfer token to said second user.

8. The system for transferring authority according to claim 7, wherein said apparatus for transferring authority includes a communication band control unit for controlling a communication band based on the class included in said utilizing transfer token.

9. A method for transferring authority from a first user to a second user, comprising:
(a) providing a transfer token to transfer a token of said first user to a third party;
(b) releasing said transfer token;
(c) providing a utilizing transfer token, said utilizing transfer token including a class of services for said first user;
(d) receiving a request to obtain said transfer token released in step (b) from said second user;
(e) providing said utilizing transfer token, said utilizing transfer token making said transfer token available to said second user; and
(f) providing said utilizing transfer token to said second user.

10. The method for transferring authority according claim 9, further comprising (g) controlling a communication band based on the class included in said utilizing transfer token when said second user utilizes said utilizing transfer token.

11. A computer readable medium embodying a program, said program causing an apparatus to perform a method for transferring authority from a first user to a second user, said method for transferring authority comprising:
(a) providing a transfer token to transfer a token of said first user to a third party;
(b) releasing said transfer token;
(c) providing a utilizing transfer token, said utilizing transfer token including a class of services for said first user;
(d) receiving a request to obtain said transfer token released in step (b) from said second user;
(e) providing said utilizing transfer token, said utilizing transfer token making said transfer token available to said second user; and
(f) providing said utilizing transfer token to said second user.

12. The computer readable medium embodying a program according to claim 11, wherein said method for transferring authority further comprises (g) controlling a communication band based on the class included in said utilizing transfer token when said second user utilizes said utilizing transfer token.
